(19) United States
(12) Patent Application Publication
(10) Pub. No.: US 2015/0052174 A1
(43) Pub. Date: Feb. 19, 2015

(54) ADAPTIVE BINNING OF VERIFICATION DATA

(71) Applicant: Samsung Electronics Co., Ltd., Gyeonggi-do (KR)

(72) Inventor: Mrinal Bose, Austin, TX (US)

(73) Assignee: Samsung Electronics Co., Ltd., Gyeonggi-do (KR)

(21) Appl. No.: 14/168,527

(22) Filed: Jan. 30, 2014

Related U.S. Application Data
(60) Provisional application No. 61/865,325, filed on Aug. 13, 2013.

(51) Int. Cl. G06F 17/30

(52) U.S. Cl. CPC G06F 17/30961; G06F 17/30292
USPC 707/797

(57) ABSTRACT

Exemplary embodiments for adaptive binning of verification data comprise defining in a memory by at least one processor a data organization tree having a self-modifying bin structure that automatically modifies in response to input raw verification data; responsive to receiving a stream of verification data, identifying patterns in the verification data based on business knowledge of subcategories of the data; and using the data organization tree to automatically bin together the verification data that match the identified patterns to provide an aggregate view of the verification data.

### CROSS-REFERENCE TO RELATED APPLICATIONS

This application claims the benefit of provisional U.S. Patent Application Ser. No. 61/865,325, filed Aug. 13, 2013 and is incorporated herein by reference.

### BACKGROUND

Design verification and functional verification includes the process of verifying that a logic design conforms to specification, which besides functional verification may also consider non-functional aspects such as timing, layout and power. Today, it may be important for entities to data-mine such verification data. Verification data may comprise both verification messages and failure messages. The verification messages may include warning messages, information messages, and data messages, while failure messages may comprise messages and comments regarding failed tests.

The verification data from design verification code may change over time as new messages are added and the design is in flux. Both the verification messages and the failure messages are typically unsorted, unordered, and generally unorganized. Conventional verification data organizational processes require a user to manually update a pattern database of messages. However, with constant changes to the verification messages, keeping the pattern database manually updated in a large project is simply not practical. For example, in digital circuit design, register-transfer level (RTL) is a design abstraction that models a digital circuit in terms of the flow of digital signals (data) between hardware registers, and logical operations performed on those signals. Data from RTL verification is constantly changing as new verification messages are added and the design is in flux. The challenge is to efficiently and automatically organize verification messages or signatures to determine the state of health of the design, failure patterns and/or a plan of action.

Standard approaches to organizing these messages involve manually maintaining a pattern database of messages and checking the number of times observed message data matches against a pattern. In other words, the standard approaches attempt to identify a variable sequence of fixed events in an event set. Such approaches work when the pattern set of events is mostly stable. However in early states of a verification project, the pattern set may constantly change. For example, a night's regression testing may generate dozens of new verification messages. Therefore, the standard approaches do not apply very well in a RTL verification environment in which pattern sets of events constantly change, because RTL message signatures have very little correlation with each other. The tests typically explore different parts of the design space and the verification messages are not coded with any template in mind. Consequently, with constant changes in the verification message data, keeping a pattern database manually updated in a large project is simply not practical.

Accordingly, what is needed is an improved method and system for efficiently and automatically organizing verification data.

### BRIEF SUMMARY

Exemplary embodiments for adaptive binning of verification data comprise defining in a memory by at least one processor a data organization tree having a self-modifying bin structure that automatically modifies in response to input raw verification data; responsive to receiving a stream of verification data, identifying patterns in verification messages based on business knowledge of subcategories of the data; and using the data organization tree to automatically bin together the verification data that match the identified patterns to provide an aggregate view of the verification data.

### BRIEF DESCRIPTION OF SEVERAL VIEWS OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an exemplary system for automatic adaptive binning of verification data;

FIG. 2 is a diagram illustrating a process for automatic adaptive binning of verification data;

FIG. 3 is a diagram illustrating an exemplary embodiment of nodes comprising an AQT tree as initially defined by the analyze tree component;

FIG. 4 is a diagram illustrating an example of adaptive binning process and adaptive query tree expansion according to one embodiment; and

FIG. 5 is a diagram showing further details of the process for expanding the AQT tree during the adaptive binning process.

### DETAILED DESCRIPTION

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Advantages and features of the present invention and methods of accomplishing the same may be understood more readily by reference to the following detailed description of embodiments and the accompanying drawings. The present general inventive concept may, however, be embodied in many different forms and should not be construed as being limited to the embodiments set forth herein. Rather, these embodiments are provided so that this disclosure will be thorough and complete and will fully convey the concept of the general inventive concept to those skilled in the art, and the present general inventive concept will only be defined by the appended claims. In the drawings, the thickness of layers and regions are exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

The term “component” or “module”, as used herein, means, but is not limited to, a software or hardware component, such as a field programmable gate array (FPGA) or an application specific integrated circuit (ASIC), which performs certain tasks. A component or module may advantageously be configured to reside in the addressable storage medium and configured to execute on one or more processors. Thus, a component or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for the components and components or modules may be combined into fewer components and components or modules or further separated into additional components and components or modules.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Exemplary embodiments provide a method and system for adaptive binning of verification data that automatically organizes the verification data. Embodiments may comprise defining a data organization tree having a self-modifying bin structure that automatically modifies in response to input raw verification data; responsive to receiving a stream of verification data, identifying patterns in the stream of verification data based on business knowledge of subcategories of the data; and binning together the verification data that matches the identified patterns to provide an aggregate view of the verification data.

According to the exemplary embodiments, the adaptive binning process may be used for, among other things, determining a state of health of the logic design, determining failure trends, and forming an action plan.

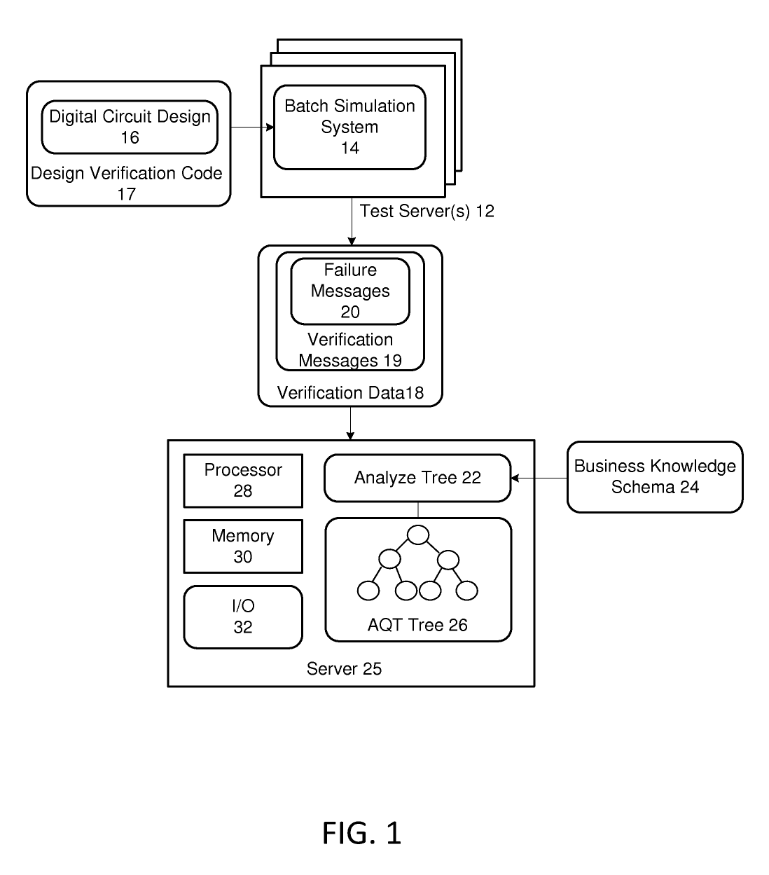

FIG. 1 is a block diagram illustrating an exemplary system for automatic adaptive binning of verification data. The system may include one or more test servers 12 that run a batch simulation system 14 for verification testing of design verification code 17, including an input digital circuit design 16. As one example, the digital circuit design 16 may represent a register-transfer level (RTL) design abstraction that models a digital circuit in terms of the flow of digital signals (data) between hardware registers, and logical operations performed on those signals. The tests performed by the batch simulation system 14 typically explore different parts of the design space and error messages and other verification data are not coded with any template in mind. Output of the batch simulation system 14 may comprise verification data 18.

As used herein, the verification data 18 may comprise verification messages 19 and failure messages 20. In one embodiment, the failure messages 20 may comprise a string of alphanumeric characters that include messages and comments, and may identify addresses, test name, test mode, and any failure time. In one embodiment, failure messages 20 can be a subset of verification failure data in general, which can be a subset of the verification data 18. Besides the failure messages 20, other types of verification messages 19 may include warning messages, information messages, data messages specifying a number of operations executed, and data messages specifying a time taken for various steps of the verification process, for example.

The verification data 18, including the failure messages 20 from the design verification code 17, may change over time as new verification messages are added and the design is in flux. Both the verification messages 19 and the failure messages 20 are typically unsorted, unordered, and generally unorganized. Conventional verification data organizational processes require a user to manually update a pattern database of failure message. However, with constant changes to the verification messages, keeping the pattern database manually updated in a large project is simply not practical.

The exemplary embodiment provides a software component referred to here as an analyze tree 22, that automatically organizes and categorizes at least a portion of the verification data 18 to determine the state of health of the digital circuit design, failure patterns and/or a plan of action. No input from a user is required during the binning process. The exemplary embodiments may perform adaptive binning on all forms of the verification data 18, including the verification messages 19 and/or the failure messages 20 using a self-modifying data organization tree structure referred to herein as an Adaptive Query Tree (AQT) 26.

In one embodiment, the analyze tree component 22 is executed on a server 25 that is in communication with the test servers 12 over a network (not shown). The network may comprise any type of wired or wireless network, including the Internet, a LAN (local area network), or WLAN (wireless local area network), for example.

One input to the analyze tree component 22 is the verification data 18, i.e., the verification messages 19 and/or the failure messages 20. In one embodiment, the verification data 18 may be represented as XML files. The verification data files may be created by an existing software integration tool, such as the one called Jenkins.

A second input to the analyze tree component 22 may be a business knowledge schema 24 specifying metadata categories of possible failures. In one embodiment, the business knowledge schema 24 may represent a data organization schema in the form of a configuration file. For example, a sample schema written specifically for the failure messages 20 may be:
“List failure message signatures in descending order of number of occurrences. For each signature, group by the test names and list in alphabetically descending order. For each test name, show instances with the shortest failure time first.”

In this example schema, possible metadata categories for sorting the failure messages 20 may include signatures created from the failure message and test names and or test modes (hereinafter test name/mode). The business knowledge schema 24 may be represented in a configuration file using a perl-data structure. The business knowledge schema 24 may be thought of as a “skeleton” of the AQT 26 with no data and with no expansion of nodes comprising the AQT 26. In one embodiment, users can edit the design verification code 17 to produce failure messages with don't care and do-care markers that may be used by the analyze tree component 22 when creating signatures.

Based on the verification data 18 and the business knowledge schema 24, the analyze tree 22 performs an automatic binning function that automatically sorts and orders the verification data 18 into the AQT 26. In one embodiment, nodes on an upper level of the adaptive query tree 26 may identify different types of verification data 18, while sub-trees below that level may represent different metadata subcategories defined in the business knowledge schema 24.

The servers 12 and 25 may comprise typical components of computing devices, including a processor 28, a memory 30, and input/output devices (I/O) 32. The memory 30, the processor 28 and the I/O 32 may be coupled together via a system bus (not shown). The memory 30 may comprise one or more memories comprising different memory types, including RAM, ROM, cache, virtual memory, flash memory, and a hard drive, for example. The processor 16 may include a single processor having one or more cores, or multiple processors having one or more cores. The I/O 32 is a collection of components that input information and output information. Example components comprising the I/O 32 include a microphone, speaker, a display and a network interface controller (or similar component) for communication over the network. The processor 28 may execute an operating system (OS) that manages hardware resources and performs basic tasks. Examples of the OS may include Linux, FreeBSD, Mac OS X, and Windows.

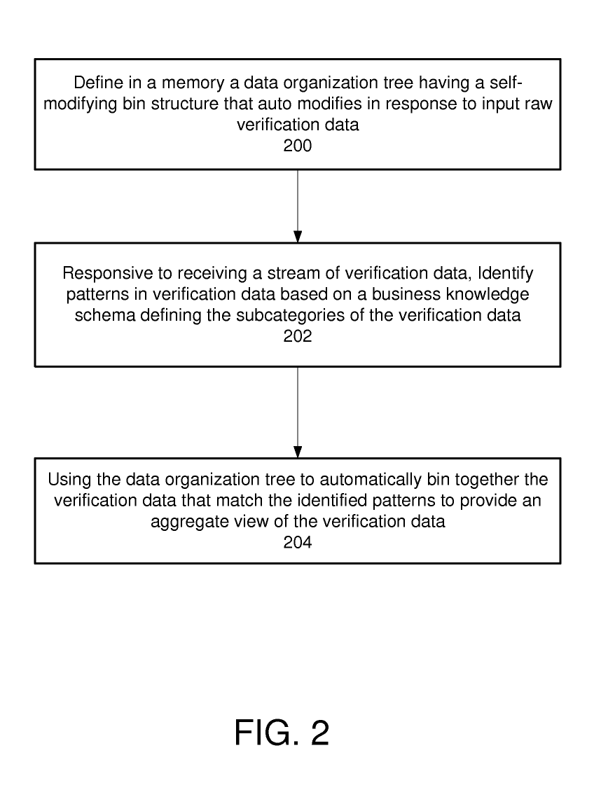

FIG. 2 is a diagram illustrating a process for automatic adaptive binning of verification data. In one embodiment, the process may be performed by the analyze tree component 22, and may begin by defining in a memory a data organization tree having a self-modifying bin structure that automatically modifies in response to input raw verification data (block 200). As described above, the analyze tree component 22 may define the data organization tree as the AQT 26, where nodes of the AQT 26 are automatically generated based on contents of the verification data, for example, verification messages 19 and/or the failure messages 20 and the input business knowledge schema 24.

Details of query trees and AQT tree nodes will now be described.

Query Tree

As is well known, a query tree (QT) is an n-ary tree structure, where each node comprising the QT has the following unique elements in addition to a standard child list for trees:

A Data Source List (DSL)

A Binning function (BF)

A Data Queue (DQ)

In some embodiments, the DSL is an array of pointers to the verification data 18 that the node will process. These pointers may be to an external array storing the verification data 18, or simply a pointer to a parent. It is possible to pull external data uniquely into a sub-tree.

The BF is a Boolean expression involving functions that take elements referred to by the DSL as arguments and return Boolean values. Functions are allowed to take other functions as arguments. Only if the expression evaluates to True, is a reference to that element inserted in the DQ.

For sibling nodes in a child list, it is possible for both their BFs to evaluate to True. This means that multiple references to the same verification data 18 may exist in different sub-trees of the tree structure. This has the advantage of allowing the AQT tree component 22 to sort the verification data 18 in a completely different fashion in different sub-trees. The increased memory requirement is minimized by only storing references in the DQs.

A function may operate on any meta-information of the verification data 18 or a combination thereof. The function may be arbitrarily complex, e.g., attempting to identify a certain string pattern in the verification data 18 called a signature, a particular test name, a particular time range of the test results, etc.

Tree nodes are evaluated in a depth-first search (DFS) manner starting at the root. At any node of a QT, its DQ points to elements which satisfy the conditions imposed by the node and all its ancestors. These can then be counted to provide a distribution of the various categories. QTs thus provide a hierarchical way to organize the data.

Adaptive Query Trees

A disadvantage of QTs is that the BFs must be specified individually. In an environment where signatures change on a daily basis, the cost of keeping the BFs updated can become prohibitive.

According to one aspect of the exemplary embodiment, adaptive query trees (AQTs) are an extension of QTs designed to solve this problem. AQT features are a true superset of QT features. A QT node may have AQTs as children or vice-versa. According to the exemplary embodiment, AQTs may include some or all of the functions of QTs in addition to the following new functions:

A Binning Function Creator Function (BFCF)

An Offspring Creator function (OCF)

A Category Creator Function (CCF).

A BFCF may take a certain verification metadata D, strip out the irrelevant information, and create a BF F based on the verification metadata D. Now if F encounters new metadata D′, which is identical to D except for the irrelevant information, F will evaluate to True. F evaluates to False in all other cases.

Once a new BFCF has been created, the OCF creates a new QT (or AQT) node Q with BF F. Q's child list is a new sub-tree T which is a clone of the original sub-tree of the AQT. The CCF adds a description to Q. While the CCF would be normally be expected to follow a similar logic to the BFCF, this is not compulsory. The OCF then adds Q to the child-list of the AQT. This process is called Tree Expansion.

Repeating this process over the entire DSL of the AQT, an expanded tree is automatically obtained, which now has the ability to categorize the various signatures. The sub-tree of the AQT may have other AQTs and the process can be repeated at the lower levels of the tree. AQTs remove the requirement for the user to know the contents of the verification metadata. Knowledge of the verification metadata categories is sufficient to perform data analysis.

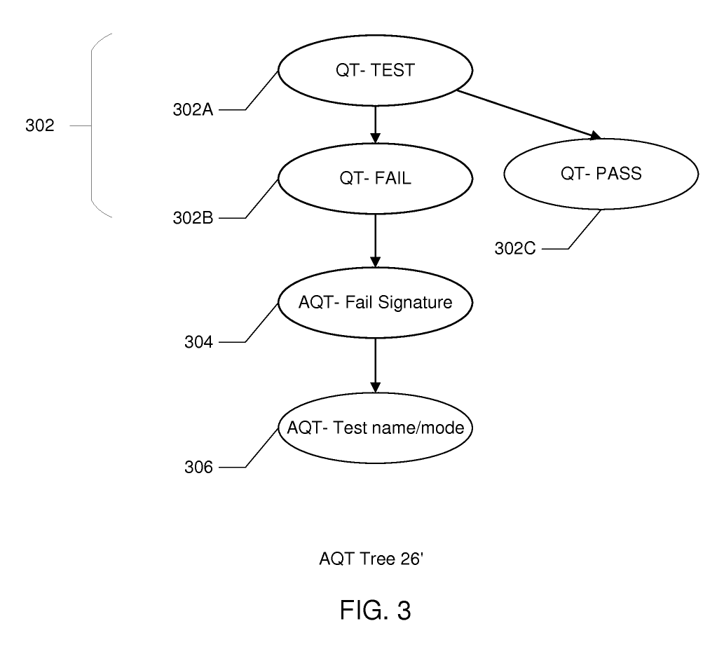

FIG. 3 is a diagram illustrating an exemplary embodiment of nodes comprising an AQT tree as initially defined by the analyze tree component 22 for analyzing failure messages 20 as an example of verification data 18. According to one embodiment, the AQT tree 26′ uses a query tree as a basic data organization building block. For example, nodes on top levels of the AQT tree 26 may comprise query trees 302 that sort and assign incoming failure messages 20 into sub-trees corresponding to a predetermined test result. More specifically, the top-level query trees 302 may sort and assign incoming failure messages 20 into sub-trees corresponding to an identified failing result or a passing result. In the example shown, nodes on the first two levels of the AQT tree 26′ may comprise query tree 302 type-nodes, e.g., QT-test 302A, QT-fail 302B, and QT-pass 302C. In this example, QT-test 302A reads the incoming test results, involving failure messages 20 and other metadata, and QT-fail 302B stores failure messages and other metadata associated with a failed test, while QT-pass 302C stores metadata associated with a passed test.

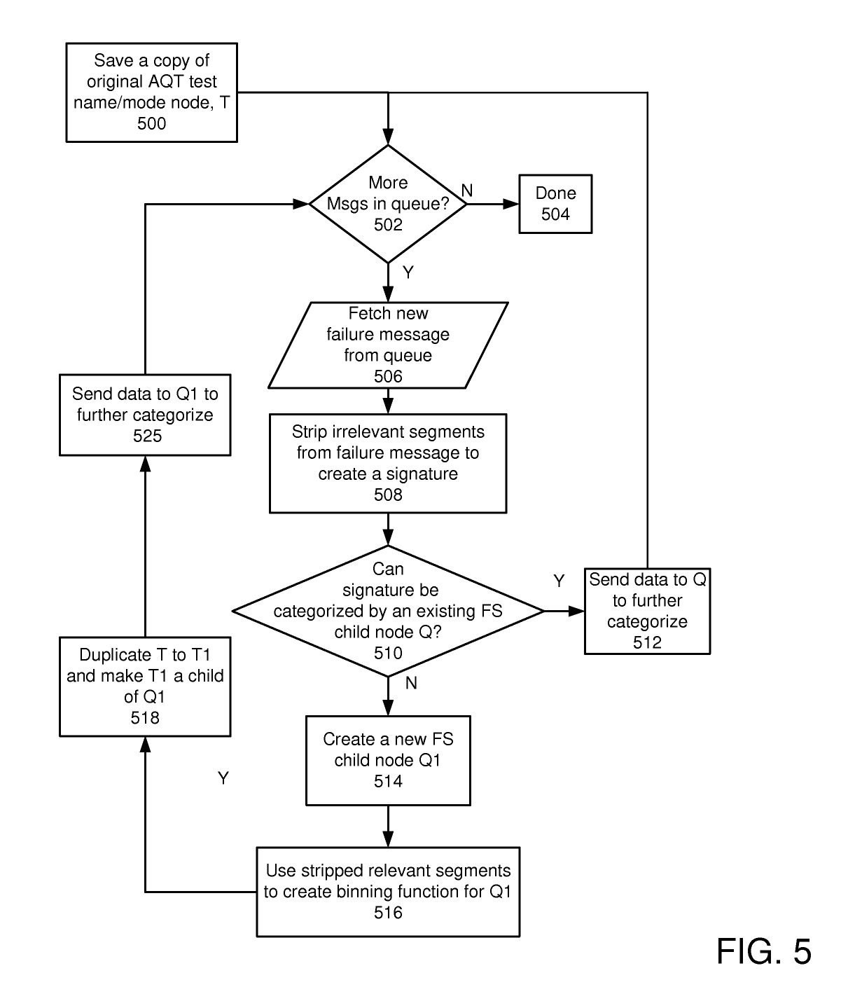

Levels of the AQT tree 26′ below the query tree levels 302, may comprise AQT type-nodes including AQT-fail signature 304 that create signatures for each of the fail messages and creates corresponding AQT sub-trees (shown in FIG. 5) for each unique signature generated.

One or more levels below the AQT-fail signature 304 may be defined to represent different metadata subcategories defined by a business knowledge schema 24. In the example shown, one level of sub-trees/nodes, referred to here as AQT-test name/test mode 306, may correspond to a test name/mode category for the failure messages. During processing, sub-tree/nodes will be created for each unique test name/mode encountered in the fail messages 20. Referring again to FIG. 2, after the AQT tree 26 is defined, the analyze tree component 22 begins processing the verification data 18 in the form of verification messages 19 and/or failure messages 20. Referring again to FIG. 2, responsive to receiving a stream of verification data 18, the analyze tree component 22 identifies patterns in the verification data based on the business knowledge schema 24 defining the subcategories of the verification data (block 202).

In one embodiment, the analyze tree component 22 identifies patterns in the verification messages 19 by creating signatures for the verification messages 19 and automatically creating respective nodes in the AQT tree corresponding to each unique signature created. In one embodiment, the analyze tree component 22 creates a child AQT signature node for each unique signature created, where the signature node is representative of that unique signature. More specifically for failure messages 20, the analyze tree component 22 may create a child AQT failure signature (FS) node for each unique signature created.

The analyze tree component 22 may create a respective message signature for each of the verification messages 19 by discarding any portions of the verification messages 19 deemed irrelevant by predefined heuristics in the business knowledge schema 24. In one embodiment, the signatures are created based on the business knowledge schema 24, which identifies particular portions of the verification messages that are irrelevant to the binning process. For example, in one embodiment, all address, data, register, and opcode information may be stripped from the verification message by default. Any information bounded by “don't care” markers defined by the business knowledge schema 24 are also discarded. Any other numeric numbers may be collapsed into a generic number, such as a binning string number. Once the irrelevant data is stripped away from the verification message, the remainder of the message forms the message signature.

The analyze tree component 22 uses the data organization tree to automatically bin together the verification data that match the identified patterns to provide an aggregate view of the verification data (block 204). In one embodiment, each signature node is responsible for binning together or storing all subsequent verification messages having matching verification message signatures. In one embodiment, each of the signature nodes are created with a binning function (BF) capable of determining if a signature created for each subsequent verification message matches the signature represented by the signature node.

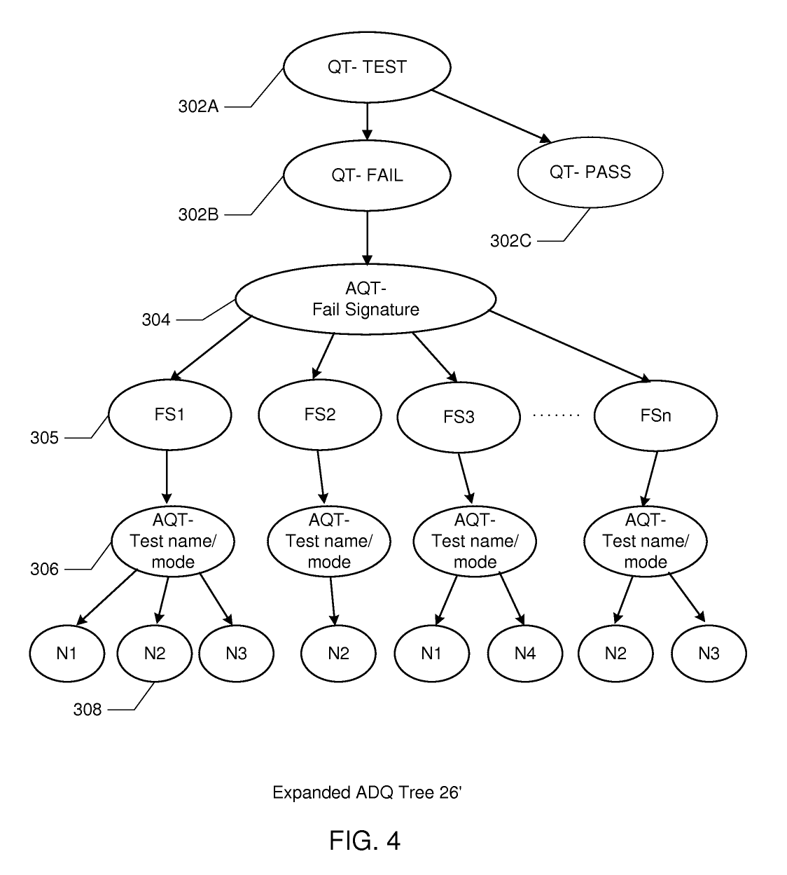

FIG. 4 is a diagram illustrating an example of an adaptive binning process for failure messages 20 and the resulting adaptive query tree expansion according to one embodiment of the present invention. The adaptive binning process may begin by expanding the adaptive query tree 26′ by the node QT-test 302A reading the failure messages 20 from the file of verification data 18 and passing the failure messages 20 to the two children nodes QT-fail 302B and QT-pass 302C. The nodes QT-fail 302B and QT-pass 302C include binning functions that determine whether the presence or absence of a failure message 20 represent a failing result or a passing result, respectively, and the failure messages 20 are assigned/stored in queues of the corresponding fail node.

Thereafter, the node AQT-fail signature 304 reads each failure message 20 assigned to the failure node, QT-fail 302B, and creates a respective failure message signature for each of the failure messages by discarding any data in the failure messages deemed irrelevant to the final binning.

Once the failure message signatures are created, it is determined if each of the failure message signatures match any existing failure signature node by comparing the failure message signature with the signatures represented by any existing failure signature nodes. If a matching failure signature node is found, the failure message is assigned to the matching failure signature node. If no matching failure signature node is found, a new AQT-type fail signature node 305 is created (e.g., FS1) and both the failure message and the failure message signature is assigned to the new fail signature node. As other failure messages are processed, other children fail signature nodes 305 may be created, shown as FS2 through FSn. Each of these FS nodes 305 has its own queue containing copies of the failure messages having signatures that match the signature of the specific FS node 305, and each has a child AQT—test name and test mode 306.

In one embodiment, AQT-fail signature 304 may pass the failure messages to each failure signature node 305, and the binning function of each failure signature node 305 determines if the failure message signature matches the signature assigned to that particular failure signature node 305. In an alternative embodiment, the AQT-fail signature 304 may pass just the failure message signatures to the binning functions of the failure signature nodes 305 instead of the entire message.

When the AQT-fail signature 304 creates a new failure signature node from a failure message, D for example, the binning function creator function (BFCF) of AQT-fail signature 304 strips out irrelevant information from the failure message D and creates a binning function (BF), F for example, for a failure signature node FS1. When the BF of the failure signature node FS1 encounters a new failure message D′ that is identical to D except for the relevant information, BF will evaluate to True and the new failure message D′ will be assigned to the failure signature node FS1. BF evaluates to False in all other cases.

Once the failure message signatures are iteratively categorized using the fail signature nodes 305, any sub-levels in the AQT tree created for each metadata subcategory defined in the business knowledge schema 24 are iteratively evaluated.

In the present example, each fail signature node 305 sends the failure messages assigned to it to these AQT child nodes/sub-trees for sub categorization. For example, the AQT test name and test mode 306 nodes for each fail signature node 305 may be used to bin together failure messages having matching test name/modes. In this second iteration, each AQT test name/mode node 306 creates child test nodes 308 shown as N1, N2, N3 and N4 depending on the test name/mode of each of the failure messages 20.

During this process, the AQT test name/mode nodes 306 determines for each of the failure messages assigned to a corresponding parent failure signature node 305 whether the test name/mode matches any existing child test node 308. If not, a new test node 308 is created, and the test name/mode name and the failure message are assigned to the new test node 308. Any subsequent failure messages from the parent failure signature node 305 will be assigned to the new test node 308. In this manner all failure messages with the same signatures and same test names/modes will be automatically binned together.

At any given FS level-node 305, it can be determined that any failure message in the queue of a given FS level-node 305 will generate a signature corresponding to the FS level-node 305. In the last row of the AQT tree 26′, any element in the test nodes 308 can be characterized as failing test N, in mode M, and it's signature is FSm.

Accordingly, the path through the AQT tree hierarchy provides a guide to the content of the failure messages or the verification data generally. The adaptive binning process of the exemplary embodiment therefore provides a solution to the problem of automatically sorting an unsorted, unordered and unorganized list of verification data without any input from the user.

FIG. 5 is a diagram showing further details of the process for expanding the AQT tree during the adaptive binning process, using failure messages as an example of verification data. The process may be performed by the analyze tree component 22 for the AQT-type nodes in the AQT tree 26.

In the beginning, a copy of the original AQT test name/mode node, T, is saved (block 500). It is determined whether there are any failure messages in the queue of the AQT fail signature node (block 502). If not, the process ends (block 504). If it is determined that there are more failure messages in the queue of the AQT fail signature node, then a new failure message is fetched from the queue (block 506). The irrelevant segments are stripped from the failure message to create a signature (block 508).

It is then determined if the failure message can be categorized by an existing child fail signature node (e.g., FS1 . . . FSn) of the AQT node by comparing the signature of the message with signatures of any existing child fail signature nodes (block 510).

If the signature matches the signature of an existing fail signature node, then the failure message is sent to the fail signature node having the matching signature for further categorization (block 512). The process then continues at determining whether there is any more failure messages in the queue (block 502).

If the signature does not match the signature for any existing fail signature node, then a new AQT fail signature node Q1 is created (block 514), and stripped relevant segments of the failure message are used to create a new binning function for the new fail signature node Q1 (block 516).

Once the new fail signature node Q1 is created, a duplicate of the AQT test name/mode node T is created called T1, and node T1 is made a child of failure signature node Q1 to replicate the categorization process for the new signature (block 518). Once an adaptive query tree is expanded, a child of a parent is also an adaptive query tree. Therefore, the children fail signature nodes created from AQT fail signature 304 are also AQT nodes.

The above process is repeated by processing the failure messages in the queues of each fail signature node. Once this process is complete, the process is repeated by processing the failure messages in the queues of each test name/mode node.

The exemplary embodiments may be implemented in a variety of ways. In one embodiment, the analyze tree 22 component that performs failure message analysis may be coded in Perl for Perl's support of three features—regular expressions, run-time evaluation (ref) and object-oriented programming. QTs/AQTs may be implemented as classes, with AQTs being a derived class of QT. A configuration file may be read in and blessed (ref) into these classes. DSLs may be recursively processed until leaf nodes are reached. The verification data 18 may be input to the analyze tree component 22 in the form of xml files, which may be created using a software integration tool, such as Jenkins. The business knowledge schema 24 may be represented in a configuration file using a Perl-data structure. Text reports, CSV and debug output formats may be supported by the system. These formats all may be implemented as derived classes of QT with appropriate display functions.

A method and system for adaptive binning of verification failure data has been disclosed. The present invention has been described in accordance with the embodiments shown, and there could be variations to the embodiments, and any variations would be within the spirit and scope of the present invention. For example, the exemplary embodiment can be implemented using hardware, software, a computer-readable medium containing program instructions, or a combination thereof. Software written according to the present invention is to be either stored in some form of non-transitory computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A method for adaptive binning of verification data, comprising:
defining in a memory by at least one processor a data organization tree having a self-modifying bin structure that automatically modifies in response to input raw verification data;
responsive to receiving a stream of verification data, identifying patterns in the verification data based on business knowledge of subcategories of the verification data; and
using the data organization tree to automatically bin together the verification data that match the identified patterns to provide an aggregate view of the verification data.

2. The method of claim 1, wherein the data organization tree comprises an adaptive query (AQT) tree, wherein nodes of the AQT tree are automatically generated based on contents of the verification data and an input business knowledge schema.

3. The method of claim 2, wherein the AQT tree comprise query trees (QT) that sort and assign verification messages in the verification data into sub-trees corresponding to a predetermined test result.

4. The method of claim 3, wherein levels of the AQT tree below the query trees comprise AQT nodes.

5. The method of claim 4, wherein identifying patterns in the verification data further comprises: creating signatures for the verification messages and automatically creating respective AQT nodes in the data organization tree corresponding to each unique signature created.

6. The method of claim 5, the method further comprising: creating a child signature node for each unique signature created, wherein the signature node is representative of that unique signature.

7. The method of claim 5, further comprising: creating the signatures based on the business knowledge schema that identifies particular portions of the verification messages that are irrelevant to the binning process.

8. The method of claim 7, wherein creating the signatures for each of the verification messages further comprises: discarding any portions of the verification messages deemed irrelevant by predefined heuristics in the business knowledge schema.

9. The method of claim 8, wherein creating the signatures further comprises: creating the signatures for each of the verification messages by stripping from each of the message address, data, register, and opcode information, as well as any information bounded by don't-care markers defined by the business knowledge schema.

10. The method of claim 7, wherein using the data organization tree to bin together the verification messages that match the identified patterns further comprises: using each of the signature nodes to bin together the verification messages having signatures that match the signature represented by the signature node.

11. The method of claim 10, wherein each of the signature nodes are created with a binning function capable of determining if the signature created for each of the verification messages matches the signature represented by the signature node.

12. The method of claim 11 wherein determining if the signature of one of the verification messages matches the signature represented by any of the signature nodes further comprises:
comparing a message signature with the signatures represented by any existing signature nodes;
if a matching signature node is found, assigning the verification message to the matching signature node;
if no matching signature node is found, creating a new signature node and assigning both the verification message and the message signature to the new signature node.

13. The method of claim 10, further comprising: once the message signatures are iteratively categorized using the signature nodes, iteratively evaluating any sub-levels in the AQT tree created for each metadata subcategory defined in the business knowledge schema.

14. A system for adaptive binning of verification data, comprising:
a memory;
a processor coupled to the memory, the processor configured to:
define in the memory a data organization tree having a self-modifying bin structure that automatically modifies in response to input raw verification data;
responsive to receiving a stream of verification data, identify patterns in the verification data based on business knowledge of subcategories of the verification data; and
use the data organization tree to automatically bin together the verification data that match the identified patterns to provide an aggregate view of the verification data.

15. The system of claim 14, wherein the data organization tree comprises an adaptive query (AQT) tree, wherein nodes of the AQT tree are automatically generated based on contents of the verification data and an input business knowledge schema.

16. The system of claim 15, wherein the AQT tree comprise query trees (QT) that sort and assign messages in the verification data into sub-trees corresponding to a predetermined test result.

17. The system of claim 16, wherein levels of the AQT tree below the query trees comprise AQT nodes.

18. The system of claim 17, wherein the processor is configured to identify patterns in the verification data further comprises: creating signatures for the verification messages and automatically creating respective AQT nodes in the data organization tree corresponding to each unique signature created.

19. The system of claim 18, wherein the processor is configured to create a child signature node for each unique signature created, wherein the signature node is representative of that unique signature.

20. The system of claim 18, wherein the processor is configured to create the signatures based on the business knowledge schema that identifies particular portions of the verification messages that are irrelevant to the binning process.

21. The system of claim 20, wherein the signatures are created for each of the failure messages further comprises: discarding any portions of the verification messages deemed irrelevant by predefined heuristics in the business knowledge schema.

22. The system of claim 8, wherein the processor is configured to create the signatures for each of the verification messages by stripping from each of the verification message address, data, register, and opcode information, as well as any information bounded by don't-care markers defined by the business knowledge schema.

23. The system of claim 21, wherein using the data organization tree to bin together the verification messages that match the identified patterns further comprises: using each of the signature nodes to bin together the messages having signatures that match the signature represented by the signature node.

24. The system of claim 23, wherein each of the signature nodes are created with a binning function capable of determining if the signature created for each of the verification messages matches the signature represented by the signature node.

25. The system of claim 24 wherein the processor is configured to determine if the signature of one of the verification messages matches the signature represented by any of the signature nodes by:
comparing a message signature with the signatures represented by any existing signature nodes;
if a matching signature node is found, assigning the verification message to the matching signature node;
if no matching signature node is found, creating a new signature node and assigning both the verification message and the message signature to the new signature node.

26. The system of claim 24, wherein once the message signatures are iteratively categorized using the signature nodes, iteratively evaluating any sub-levels in the AQT tree created for each metadata subcategory defined in the business knowledge schema are iteratively evaluated.

27. A computer-readable medium containing program instructions for adaptive binning of verification data, the program instructions comprising:
defining in a memory by at least one processor a data organization tree having a self-modifying bin structure that automatically modifies in response to input raw verification data;
responsive to receiving a stream of verification data, identifying patterns in the verification data based on business knowledge of subcategories of the verification data; and
using the data organization tree to automatically bin together the verification data that match the identified patterns to provide an aggregate view of the verification data.

28. The computer-readable medium of claim 27, wherein the data organization tree comprises an adaptive query (AQT) tree, wherein nodes of the AQT tree are automatically generated based on contents of in the verification data and an input business knowledge schema.

29. The computer-readable medium of claim 28, wherein the AQT tree comprise query trees (QT) that sort and assign verification messages in the verification data into sub-trees corresponding to a predetermined test result.

30. The computer-readable medium of claim 29, wherein levels of the AQT tree below the query trees comprise AQT nodes.

31. The computer-readable medium of claim 29, wherein identifying patterns in the verification data further comprises: creating signatures for the verification messages and automatically creating respective AQT nodes in the data organization tree corresponding to each unique signature created.

32. The computer-readable medium of claim 31, the computer-readable medium further comprising: creating a child signature node for each unique signature created, wherein the signature node is representative of that unique signature.

33. The computer-readable medium of claim 31, further comprising: creating the signatures based on the business knowledge schema that identifies particular portions of the verification messages that are irrelevant to the binning process.

34. The computer-readable medium of claim 33, wherein creating the signatures for each of the verification messages further comprises: discarding any portions of the verification messages deemed irrelevant by predefined heuristics in the business knowledge schema.

35. The computer-readable medium of claim 34, wherein creating the signatures further comprises: creating the signatures for each of the verification messages by stripping from each of the message address, data, register, and opcode information, as well as any information bounded by don't-care markers defined by the business knowledge schema.

36. The computer-readable medium of claim 33, wherein using the data organization tree to bin together the verification messages that match the identified patterns further comprises: using each of the signature nodes to bin together the verification messages having signatures that match the signature represented by the signature node.

37. The computer-readable medium of claim 36, wherein each of the signature nodes are created with a binning function capable of determining if the signature created for each verification messages matches the signature represented by the signature node.

38. The computer-readable medium of claim 37 wherein determining if the signature of one of the verification messages matches the signature represented by any of the signature nodes further comprises:
comparing a message signature with the signatures represented by any existing signature nodes;
if a matching signature node is found, assigning the verification message to the matching signature node;
if no matching signature node is found, creating a new signature node and assigning both the verification message and the message signature to the new signature node.

39. The computer-readable medium of claim 36, further comprising: once the message signatures are iteratively categorized using the signature nodes, iteratively evaluating any sub-levels in the AQT tree created for each metadata subcategory defined in the business knowledge schema.
